(19) United States
(12) Patent Application Publication
(10) Pub. No.: US 2024/0274032 A1
(43) Pub. Date: Aug. 15, 2024

(54) CODING ALGORITHM TRAINING TOOL CAPABLE OF SPEECH RECOGNITION

(71) Applicant: CREAMO INC., Seoul (KR)

(72) Inventors: Seok LEE, Seoul (KR); Gang Hyun CHO, Seongnam-si (KR)

(21) Appl. No.: 18/573,459

(22) PCT Filed: Dec. 20, 2021
(86) PCT No.: PCT/KR2021/019357

§ 371 Date: Dec. 22, 2023

(30) Foreign Application Priority Data
Jul. 13, 2021 (KR) 10-2021-0091460

(51) Int. Cl. G09B 19/00; A63H 33/04; A63H 33/08; G06F 3/0486; G06F 3/16; G10L 15/22

(52) U.S. Cl. CPC G09B 19/0053; A63H 33/042; G06F 3/0486; G06F 3/167; G10L 15/22; A63H 33/086; G10L 2015/223

(57) ABSTRACT

Proposed is a coding algorithm training tool. More particularly, proposed is a coding algorithm training tool capable of speech recognition, wherein an assembly module formed in the shape of a block is formed to be attachable to or detachable from an existing block, and coding for the assembly module is performed through the control module and a result of coding is immediately checked through the assembly module attached to the block, whereby intuitive and interesting coding education is given to children and coding performed through the control module is achieved through speech recognition, further increasing convenience of and interest in coding.

### TECHNICAL FIELD

The present disclosure relates to a coding algorithm training tool. More particularly, the present disclosure relates to a coding algorithm training tool capable of speech recognition, wherein an assembly module formed in the shape of a block is formed to be attachable to or detachable from an existing block, and coding for the assembly module is performed through the control module and a result of coding is immediately checked through the assembly module attached to the block, whereby intuitive and interesting coding education is given to children and coding performed through the control module is achieved through speech recognition, further increasing convenience of and interest in coding.

### BACKGROUND ART

Block play toys are toys that can be enjoyed by completing shapes and figures with several pieces in various three-dimensional shapes, such as rectangular and cylindrical, connected to each other in a fixed and fitted manner or arranged. Assembling the pieces may provide infants or children with various educational effects, and assembling various models may improve intelligence and creativity. Recently, these block toys have been advanced into smart blocks that provide functionality, such as IoT. Regarding boards on which such smart blocks are arranged, board products with various smart functionalities are being developed.

However, in the case of conventional smart blocks or block products for coding education, learning or play is achieved by simply arranging, listing, or sequencing the smart blocks that realize a particular functionality. Coding education also remains at the level of inputting mathematical functions of a particular function to particular smart blocks for realization and executing the function.

In the case of “SMART BLOCK” disclosed in the patent document below, a smart block with a wireless communication function as well as functionality for various inputs and outputs is used by being combined with existing assembly block toys so as to provide creative play and education. However, in fact, the patent in the related art does not disclose any special concept other than the implementation of functions by connection between the smart blocks, and does not disclose problem recognition or solution tasks for coding education.

(Patent Document) Korean Patent No. 10-1915939 (registered, 31 Oct. 2018) “SMART BLOCK FOR CHILD”

### DISCLOSURE

### Technical Problem

Accordingly, the present disclosure has been made keeping in mind the above problems occurring in the related art, and

the present disclosure is directed to providing a coding algorithm training tool, wherein an assembly module formed in the shape of a block is formed to be attachable to or detachable from an existing block, and coding for the assembly module is performed through a control module and a result of coding is immediately checked through the assembly module attached to the block, whereby intuitive and interesting coding education is given to children and coding performed through the control module is achieved through speech recognition, further increasing convenience of and interest in coding.

The present disclosure is directed to providing a coding algorithm training tool that allows an operation menu that may be applied when speech for coding is recognized to be checked and executed, thereby achieving accurate coding through speech recognition.

The present disclosure is directed to providing a coding algorithm training tool that enables coding work to be completed only by dragging and dropping command entries, which are displayed on a screen of the control module, according to order, so that children can easily experience coding work and the dragging and dropping operation is performed through speech recognition for experience of easier coding work.

The present disclosure is directed to providing a coding algorithm training tool that displays command entries on the working screen of the control module in everyday terms, and automatically converts entries in everyday terms into programming language for compiling, whereby a user who does not known the programming language can easily conduct coding.

The present disclosure is directed to providing a coding algorithm training tool that displays, when a flaw occurs in a control code resulting from compiling, the flaw on the working screen, whereby the flaw in coding can be easily checked.

The present disclosure is directed to providing a coding algorithm training tool transmits identification that information of each assembly module from the assembly module to the control module, and coding is performed by selecting identification information through control module, thereby achieving accurate and easy coding for a plurality of assembly modules.

The present disclosure is directed to providing a coding algorithm training tool that enables identification information to be designated by simply selecting or by dragging and dropping the identification information transmitted from an assembly module on the working screen so that the identification information can be easily selected and coding is performed for multiple assembly modules with a mouse or screen touch, and that enables selecting or dragging and dropping for designating identification information to be done through speech recognition, making it easily to designate the identification information.

The present disclosure is directed to providing a coding algorithm training tool that automatically transmits identification information along with the supply of power to an assembly module, making selection of identification information and coding easy without special manipulation or operation.

The present disclosure is directed to providing a coding algorithm training tool that supplies power from a battery to an assembly module when a pressure switch is pressed according to the combination of the assembly module to a block, and that breaks electrical connection to the battery when the assembly module is separated from the block and the pressure switch returns to its original position, so that power is supplied only when the assembly module is combined and the standby power consumption of the assembly module can thus be minimized.

The present disclosure is directed to providing a coding algorithm training tool that enables combination of various assembly modules through pairing connection between assembly modules, and also enables setting/modifying/controlling of the performance functions of the assembly modules according to the mission of learning or play, and enables various types of learning or play to be realized through sequence control of functions even with limited assembly modules.

### Technical Solution

In order to achieve the objectives above, the present disclosure is realized by an embodiment having the following configurations.

According to an embodiment of the present disclosure, there is provided a coding algorithm training tool according to the present disclosure, the coding algorithm training tool including: an assembly module formed according to specifications of a playing block to be attachable to or detachable from the block; and a control module configured to set operation of the assembly module through coding and modify or change the operation, and enable coding of a control command for the assembly module through speech recognition.

According to another embodiment of the present disclosure, in the coding algorithm training tool according to the present disclosure, the control module may include a speech recognition part configured to recognize speech and apply the speech to coding, wherein the speech recognition part may include: a speech information reception module configured to receive the speech from outside; an execution menu search module configured to select a menu to be applied to coding, according to the received speech; an application confirmation module configured to output a confirmation signal for the found menu; a control command reception module configured to receive the control command according to the speech when the menu is confirmed; and a control application module configured to apply the received control command to coding.

According to still another embodiment of the present disclosure, in the coding algorithm training tool according to the present disclosure, the control module may include: an interface part configured to provide a working screen for coding the control command for the assembly module; and a coding processing part configured to compile content coded on the working screen of the interface part, and transmit a control code resulting from compiling to a particular assembly module so that operation according to the control code is performed.

According to still another embodiment of the present disclosure, in the coding algorithm training tool according to the present disclosure, the interface part may include: a first area in which a plurality of selectable command entries are displayed on the working screen; and a second area to which the entries selected in the first area are dragged and dropped, and the coding processing part may include: a compile processing module configured to compile the entries according to arrangement order of the plurality of entries arranged in the second area; and a control code transmission module configured to transmit the control code resulting from compiling by the compile processing module to the assembly module, and the control command reception module may be configured to enable the entries in the first area to be dragged and dropped to the second area according to the command based on the speech.

According to still another embodiment of the present disclosure, in the coding algorithm training tool according to the present disclosure, the interface part may be configured to display the entries in everyday terms in the first area, and the coding processing part may include a conversion processing module configured to convert the everyday terms into programming language for compiling by the compile processing module.

According to still another embodiment of the present disclosure, in the coding algorithm training tool according to the present disclosure, the coding processing part may include: a flaw analysis module configured to analyze a flaw in the control code resulting from compiling by the compile processing module; and a flaw display module configured to display the flaw on the working screen when the flaw exists as a result of analysis by the flaw analysis module, and the control code transmission module may be configured to transmit the control code resulting from compiling to the assembly module when the flaw analysis module determines that there is no flaw.

According to still another embodiment of the present disclosure, in the coding algorithm training tool according to the present disclosure, the assembly module may include: a casing formed to be attachable to or detachable from the playing block; an execution processing part configured to receive a control code from the control module so that operation according to the control code is performed; and a battery configured to supply power to the assembly module.

According to still another embodiment of the present disclosure, in the coding algorithm training tool according to the present disclosure, the assembly module may include: an ID module configured to store identification information of each assembly module, and transmit the stored identification information to the control module, and a coding processing part may include a coding target specifying module configured to specify a coding target according to selection of the identification information transmitted by the ID module.

According to still another embodiment of the present disclosure, in the coding algorithm training tool according to the present disclosure, the coding target specifying module may include: an identification information display module configured to display the identification information transmitted by the ID module on a working screen; an identification information selection module configured to enable, when the identification information displayed by the identification information display module is selected for an object item of entries or dragged and dropped to the object item, the identification information to be selected as the coding target; and an identification information designation module configured to designate the selected identification information as the coding target for the entries, and the control application module may be configured to enable the identification information to be selected for or to be dragged and dropped to the object item according to reception of a speech command.

According to still another embodiment of the present disclosure, in the coding algorithm training tool according to the present disclosure, the assembly module may include a switching part configured to enable power to be supplied from the battery to the assembly module according to combination of the casing to the block, and the ID module may be configured to operate automatically as the power is supplied from the battery by the switching part, and transmit the identification information to the control module.

According to still another embodiment of the present disclosure, in the coding algorithm training tool according to the present disclosure, the switching part may include a pressure switch configured to be physically pressed to make electrical connection to the battery when the casing is mounted on the block, and configured to return to an original state to break the electrical connection when the casing is separated from the block.

According to still another embodiment of the present disclosure, in the coding algorithm training tool according to the present disclosure, the assembly module may include: an input block configured to generate and transmit various input signals; an output block configured to output various output signals; and a logic block configured to generate and transmit control signals required for various logical operations.

According to still another embodiment of the present disclosure, in the coding algorithm training tool according to the present disclosure, the assembly module may include: a pairing module configured to enable information to be transmitted and received through pairing between the assembly modules; a function module configured to enable a particular function to be set or modified; and a sequence control module configured to set a sequence related to an operating condition, operating order, and repetition for each of a plurality of the assembly modules.

According to still another embodiment of the present disclosure, in the coding algorithm training tool according to the present disclosure, the control module may include: a pairing control module configured to transmit a control signal related to pairing connection to the assembly module; and a function control module configured to set or modify a particular function for the function module of a particular assembly module.

### Advantageous Effects

According to the above-described embodiments and the following features, combinations, and relations of use that will be described later, the present disclosure has the following effects.

According to the present disclosure, an assembly module formed in the shape of a block is formed to be attachable to or detachable from an existing block, and coding for the assembly module is performed through the control module and a result of coding is immediately checked through the assembly module attached to the block, whereby intuitive and interesting coding education is given to children and coding performed through the control module is achieved through speech recognition, further increasing convenience of and interest in coding.

The present disclosure allows an operation menu that may be applied when speech for coding is recognized to be checked and executed, thereby achieving accurate coding through speech recognition.

The present disclosure enables coding work to be completed only by dragging and dropping command entries, which are displayed on a screen of the control module, according to order, so that children can easily experience coding work and the dragging and dropping operation is performed through speech recognition for experience of easier coding work.

The present disclosure displays command entries on the working screen of the control module in everyday terms, and automatically converts entries in everyday terms into programming language for compiling, whereby a user who does not known the programming language can easily conduct coding.

The present disclosure displays, when a flaw occurs in a control code resulting from compiling, the flaw on the working screen, whereby the flaw in coding can be easily checked.

The present disclosure transmits identification information of each assembly module from the assembly module to the control module, and coding is performed by selecting identification information through control module, thereby achieving accurate and easy coding for a plurality of assembly modules.

The present disclosure enables identification information to be designated by simply selecting or by dragging and dropping the identification information transmitted from an assembly module on the working so that the identification information can be easily selected and coding is performed for multiple assembly modules with a mouse or screen touch, and enables selecting or dragging and dropping for designating identification information to be done through speech recognition, making it easily to designate the identification information.

The present disclosure automatically transmits identification information along with the supply of power to an assembly module, making selection of identification information and coding easy without special manipulation or operation.

The present disclosure supplies power from a battery to an assembly module when a pressure switch is pressed according to the combination of the assembly module to a block, and breaks electrical connection to the battery when the assembly module is separated from the block and the pressure switch returns to its original position, so that power is supplied only when the assembly module is combined and the standby power consumption of the assembly module can thus be minimized.

The present disclosure enables combination of various assembly modules through pairing connection between assembly modules, and also enables setting/modifying/controlling of the performance functions of the assembly modules according to the mission of learning or play, and enables various types of learning or play to be realized through sequence control of functions even with limited assembly modules.

### DESCRIPTION OF DRAWINGS

FIG. 1 is a schematic diagram illustrating a coding algorithm training tool according to an embodiment of the present disclosure

FIG. 2 is a configuration diagram of a control module of FIG. 1

FIG. 3 is a schematic diagram illustrating a working screen displayed on a display by the control module

FIG. 4 is a block diagram illustrating a configuration of a coding processing part of FIG. 2

FIG. 5 is a schematic diagram illustrating identification information of an assembly module displayed through an interface part

FIG. 6 is a block diagram illustrating a configuration of a speech recognition part of FIG. 2

FIG. 7 is a configuration diagram of the assembly module of FIG. 1

FIG. 8 is a schematic diagram illustrating a switching part of the assembly module

FIG. 9 is a reference diagram illustrating types of assembly modules of a coding algorithm training tool according to another embodiment of the present disclosure

FIG. 10 is a block diagram illustrating a configuration of the assembly module of FIG. 9

FIG. 11 is a block diagram illustrating a configuration of the control module of FIG. 9

### BEST MODE

Hereinafter, preferred examples of a coding algorithm training tool capable of speech recognition according to the present disclosure will be described in detail with reference to the accompanying drawings. In describing the present disclosure, it is to be noted that if a detailed description of the known function or configuration makes the subject matter of the present disclosure unclear, the detailed description will be omitted. Throughout the specification, when a part “includes” an element, it is noted that it may further include other elements, but does not exclude other elements, unless specifically stated otherwise. In addition, the terms “ . . . part”, “ . . . module”, and the like mean a unit for processing at least one function or operation and may be implemented by hardware or software or a combination thereof.

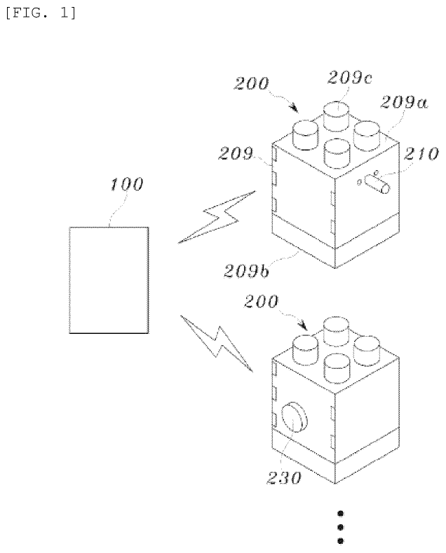

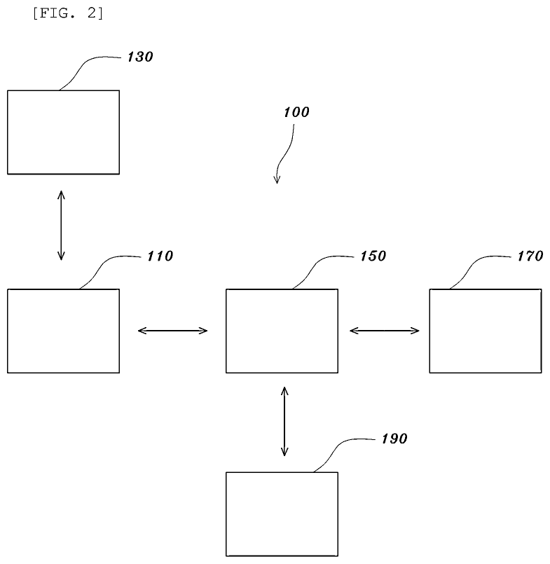

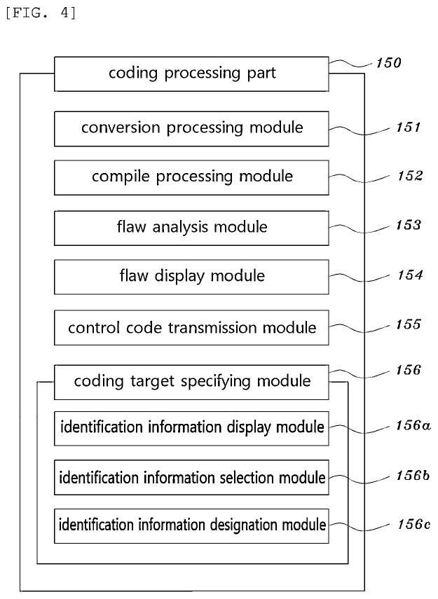

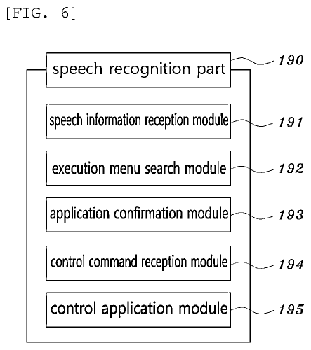

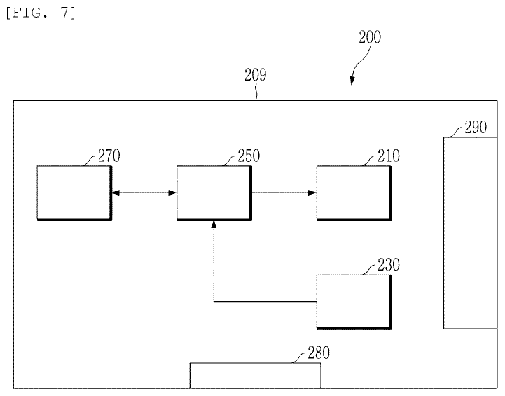

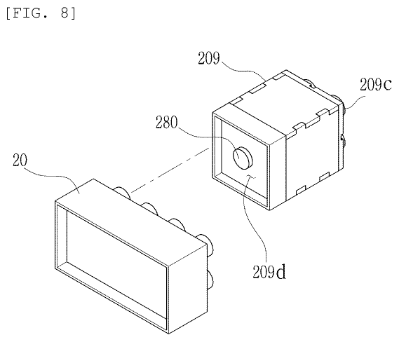

A coding algorithm training tool capable of speech recognition according to an embodiment of the present disclosure will be described with reference to FIGS. 1 to 8. The coding algorithm training tool may include: an assembly module 200 formed according to specifications of a playing block 20 to be attachable to or detachable from the block 20; and a control module 100 configured to set operation of the assembly module 200 through coding and modify or change the operation. In particular, the control module 100 enables coding of a control command for the assembly module through speech recognition.

The coding algorithm training tool according to the present disclosure enables the assembly module 200 to be attached to or detached from the existing playing block 20 so that a coding algorithm is experienced. The coding algorithm training tool realizes a coding algorithm through the control module 100 and makes the assembly module 200 operate according to the realized algorithm, enabling a result of coding to be intuitively checked and effective coding education to be given.

The assembly module 200 is an element formed to be attachable to or detachable from the playing block 20. For example, the assembly module 200 may be formed according to the specifications of the playing block 20, such as Lego. In other words, the assembly module 200 may be formed in the same shape and the same size as the block 20, and may itself function as a block. As a result, the assembly module 200 and the block 20 may be mixed and assembled together, or may be disassembled from a block assembly. The assembly module 200 may be controlled by the control module 100. The reason that the assembly module 200 is formed according to the same specifications as the block is to provide an environment in which users (mainly, young age groups) can easily form various objects and can intuitively check how the formed objects operate by coding. For example, the user may build a car using the block. Herein, the block includes the assembly module 200, and the user may intuitively understand and learn the algorithm by which the car moves, through the assembly module 200. The assembly module 200 will be described in detail later.

The control module 100 is an element that controls the assembly module 200. Unlike a general remote controller whose function is already determined, the control module 100 may provide an environment in which the user is capable of directly coding a program for controlling the assembly module 200. When there is a flaw in the coding, the assembly module 200 may not operate normally. For example, the block car may remain stationary despite being commanded to drive. Conversely, when there is no flaw in the coding, the assembly module 200 operates normally and the car built with the block may move forward. Through the assembly module 200 intuitively checked, the user may naturally learn the effects of coding, coding sequence, and coding method. In particular, the control module 100 is configured to recognize speech and enable coding of a control command for the assembly module 200 through user speech, thereby making more fun and easier coding experience and learning. The control module 100 may include: an interface part 110 providing a working screen 119 for coding a control command for the assembly module 200; a storage part 130; a coding processing part 150; a first communication part 170 transmitting a control code created through the working screen 119 to the assembly module 200; and a speech recognition part 190 recognizing speech information for coding. Part of the control module 100 may be realized by a personal computer, and the other may be realized by various terminals, such as a smartphone and a tablet PC. For example, at least one selected from the group of the interface part 110, the storage part 130, the coding processing part 150, and the speech recognition part 190 may be mounted in the personal computer. Of course, it is also possible to arrange all the interface part 110, the storage part 130, the coding processing part 150, the first communication part 170, and the speech recognition part 190 separately from the personal computer.

The interface part 110 is an element that provides the working screen 119 for coding a control command for a target object. Herein, the target object may include the assembly module 200, or may include the assembly module 200 and other objects. Various menus, such as command entries, may be displayed on the working screen 119, and the menus may be stored in the storage part 130. The interface part 110 may extract menu information stored in the storage part 130 and frame information of the working screen 119 and may display the information on the display. The interface part 110 may include various displays 111, such as a liquid crystal display (LCD) and an organic light-emitting diode (OLED) display, providing the working screen 119. In addition, the interface part 110 may include various input means 113, such as a keyboard and a mouse, for inputting commands on the working screen 119. The interface part 110 may enable commands to be input with speech recognition through the speech recognition part 190 without the input means 113.

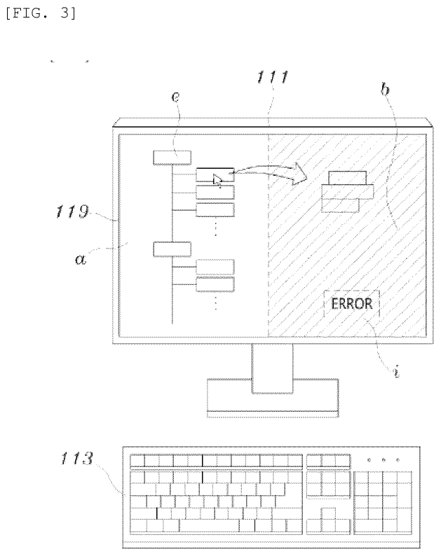

As shown in FIG. 3, the interface part 110 may display a plurality of selectable command entries e in a first area a of the working screen 119 displayed on the display. The command entries e may be formed to be user-friendly.

The entries may represent one sentence (technical term) in a program, and in principle, a sentence in the program must be written using the grammar and various phrases prescribed in the relevant programming language. However, for general users who are not specialized in the programming language, especially young age groups, it is difficult to learn the grammar and phrases used only in the programming language. The command entries e described in the present specification may include the grammar or phrases prescribed in the programming language as they are. Alternatively, for user convenience, the command entries e described in the present specification may be results of converting the complex grammar or regulations into terms of everyday life.

The interface part 110 may display the entries e in the first area a of the screen so that the user can easily find the entries e that he or she wants. In the drawing, the first area a may correspond to the area to the left of the vertical dotted line drawn in the middle of the working screen 119. The interface part 110 may set a second area b in the working screen 119. The entries e selected in the first area a are dragged and dropped to the second area b. In the drawing, the second area b may correspond to the area to the right of the vertical dotted line in the middle of the working screen 119. Herein, dragging and dropping the entries e to the second area b may be performed through speech recognition.

The coding processing part 150 is an element that complies the content (command, phrase, sentence, text, etc.) coded on the working screen 119. The coding processing part 150 converts the content into a control code that the assembly module 200 can recognize, and transmits the control code to the assembly module 200, so that the assembly module 200 operates according to coding. The coding processing part 150 may compile a plurality of entries e arranged in the second area b according to the arrangement order of the plurality of entries e arranged in the second area b. When the entries e are displayed in a general language different from the programming language, a process of converting the general language into the programming language may be performed first. In addition, the coding processing part 150 may analyze a flaw in the control code resulting from compiling the entries e. When there is a flaw, the coding processing part 150 displays the flaw so that coding errors are immediately recognized. In addition, only when there is no flaw, the coding processing part 150 transmits the control code to a specified assembly module 200 so that the assembly module 200 operates according to the control code. In addition, the coding processing part 150 may specify a control target for the control code resulting from compiling. The coding processing part 150 displays the identification information transmitted from the assembly module 200 on the working screen 119, and specifies a target to be controlled, that is, the assembly module 200, according to selection of the identification information so that coding for the specified assembly module 200 is performed. To this end, the coding processing part 150 may include a conversion processing module 151, a compile processing module 152, a flaw analysis module 153, a flaw display module 154, a control code transmission module 155, and a coding target specifying module 156.

The conversion processing module 151 is an element that converts entries e displayed in a general language into the programming language. When the entries e are displayed in general everyday terms for users do not know the programming language, such as young age groups, the entries e are converted into the programming language for compiling.

The compile processing module 152 is an element that compiles the entries e to create a control code. Compiling is performed according to the arrangement order of the plurality of entries e arranged in the second area b. For example, the entries e may include major categories and minor categories, and the major categories may include an execution conditions and execution details. The execution conditions may include minor categories, such as “when the ˜ button is pressed” and “when the ˜ button is pressed three times”, in a tree format. The execution details may include minor categories, such as “turn the ˜ motor 10 times” and “turn the ˜ motor 30 degree angles”. Accordingly, the compile processing module 152 compiles such entries e to create a control code, and transmits the created control code to each assembly module 200 so that the operation according to the entries e is executed in the assembly module 200.

The flaw analysis module 153 is an element that analyzes a flaw in the control code resulting from compiling by the compile processing module 152 so that the control code that cannot be executed is displayed to notify of coding errors.

The flaw display module 154 is an element that displays, when the flaw analysis module 153 performs analysis and determines that the control code has a flaw, the flaw on the working screen 119. As shown in FIG. 3, a flaw i may be displayed in the form of “ERROR”.

The control code transmission module 155 is an element that transmit the control code resulting from compiling to the assembly module 200 so that the assembly module 200 operates according to the transmitted control code. In particular, the control code transmission module 155 transmits the control code only when the flaw analysis module 153 determines that there is no flaw, so that the assembly module 200 operates smoothly. The control code transmission module 155 transmits the control code to the assembly module 200 specified by the coding target specifying module 156 so that accurate coding and operation may be performed for a plurality of assembly modules 200.

The coding target specifying module 156 is an element that specifies an assembly module 200 for which coding is to be performed. When a plurality of assembly modules 200 are to be operated, each assembly module 200 is specified and coding is performed, thereby achieving accurate coding and operation for each assembly module 200. To this end, the coding target specifying module 156 may include: an identification information display module 156a that receives identification information transmitted from each assembly module 200 and displays the identification information on the working screen 119; an identification information selection module 156b for selecting the identification information on the working screen 119; and an identification information designation module 156c for designating the assembly module 200 to be controlled, according to selection of the identification information.

For example, when there are three assembly modules 200 equipped with buttons, there is a selection problem about writing which assembly module 200's button is indicated. In order to solve the selection problem, identification information of each assembly module 200 is required. However, when a paper manual in which photos and identification information of a plurality of assembly modules 200 are mentioned together is provided, the user finds the photo of the assembly module 200 that he or she wants from the manual in which the photos and identification information of the plurality of assembly modules 200 are noted, and memorizes the identification information noted matching the photo of the assembly module 200 to write the identification information in the blank for an object item of the entries. This work is very inconvenient and it is difficult to accurately specify an identification target. When the user accidentally inputs the identification information of the assembly module 200 not in a ready state, in other words, the identification information of the assembly module 200 not assembled to another block, the entries do not operate normally.

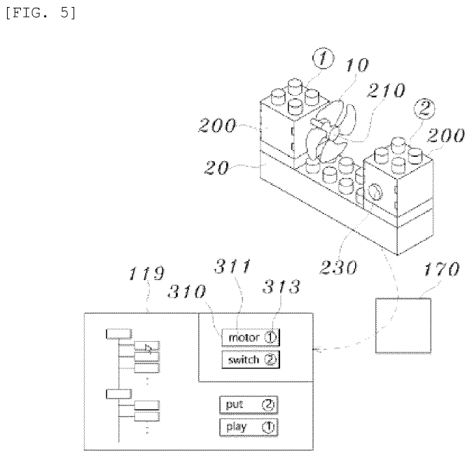

For example, as shown in FIG. 5, the user may assemble a block to an assembly module 200 \textcircled{1} equipped with a first motor and an assembly module 200 \textcircled{2} equipped with a blue button. Afterward, the user may perform the coding work to realize the algorithm by which the first motor (including the motor shaft) provided at the assembly module 200 \textcircled{1} rotates when the blue button of the assembly module 200 \textcircled{2} is pressed. The user may find the execution condition “when the ˜ button is pressed” among the entries displayed in the first area a of the working screen 119 and may drag and drop the execution condition in the second area b, and may find the execution detail “turn the ˜ motor 10 times” among the entries and may place the execution detail below “when the ˜ button is pressed” placed in the second area b.

Herein, the identification information of the assembly module 200 needs to be written in the object item denoted by “˜” in “when the ˜ button is pressed”. Similarly, the identification information of the assembly module 200 also needs to be written in the object item denoted by “˜” in “turn the ˜ motor 10 times”. When identification information is provided in a paper manual, the user needs to search the manual manually for the identification information of the assembly module 200 and recognizes the identification information. In addition, it may be difficult to distinguish which one of a plurality of assembly modules 200 equipped with motors is the assembly module 200 that the user has assembled.

Referring to FIG. 5, in the object item denoted by “˜” in “turn the ˜ motor 10 times” (mentioned as “play” in the drawing), the identification information of the assembly module 200 \textcircled{1} provided with the first motor corresponding to a first execution part 210 needs to be input. When identification information of another assembly module 200 equipped with a motor is written in the object item, the first motor and the vanes provided at the assembly module 200 \textcircled{1} shown in FIG. 5 cannot rotate.

Referring to FIG. 5, in the object item denoted by “˜” in “when the ˜ button is pressed” (mentioned as “put” in the drawing), the identification information of the assembly module 200 \textcircled{2} provided with the blue button corresponding to a second execution part 230 needs to be input. When identification information of another assembly module 200 equipped with a button is written in the object item, the first motor cannot rotate no matter how many the button of the assembly module 200 \textcircled{2} shown in FIG. 5 is pressed. In this case, the user needs to endure the inconvenience of searching the manual again for the identification information of the assembly module 200 \textcircled{1} or the assembly module 200 \textcircled{2}. The coding algorithm training tool of the present disclosure is intended to promote coding learning and algorithm learning, and is not intended to develop a manual searching skill. In addition, the manual searching work may cause serious fatigue.

Therefore, in order to comply with the purpose of the present disclosure and suppress an increase in user fatigue, the coding target specifying module 156 receives identification information of a target object in a ready state capable of receiving a control code and displays the identification information on the working screen 119 through the identification information display module 156a.

For example, the assembly module 200 assembled to the block may allow power in a battery 290 to be supplied to the assembly module 200 when a switching part 280 is turned on, and the assembly module 200 to which power is supplied transmits the identification information automatically to the control module 100 so that the identification information is displayed on the working screen 119 of the control module 100 by the identification information display module 156a. In the meantime, if only pure identification information, such as a unique number, is displayed on the working screen 119, it may be difficult for the user to recognize which assembly module 200 is indicated by the identification information. Therefore, in order to easily determine which assembly module 200 is indicated by the identification information displayed on the working screen 119, classification information 311, such as “motor” or “switch”, indicating the type of the assembly module 200 and the assembly module's 200 own unique number 313, such as “\textcircled{1}” or “\textcircled{2}”, are displayed together as the identification information 310. Herein, when the identification information is selected while an object item of the entries coded on the working screen 119 is selected or when the identification information is dragged and dropped to the object item, the identification information is written in the object item by the identification information selection module 156b. The written identification information may be registered and stored as identification information of a control target for the entries by the identification information designation module 156c. Herein, the selecting or the dragging and dropping of the identification information by the identification information selection module 156b may be performed through speech recognition by the speech recognition part 190. In addition, at this time, it is proved that the identification information displayed on the working screen 119 is used in the block assembly. The entries in which the identification information is written may guarantee that the assembly module 200 operates. The user may examine the operation of the block assembly and may modify the coding content according to the direction that he or she wants.

The storage part 130 store therein various information related to coding for controlling the assembly module 200. Various wired/wireless communication means capable of communicating with the assembly module 200 are applied to the first communication part 170, so the first communication part 170 may enable coding for each assembly module 200 and the corresponding control code to be transmitted to the assembly module 200, and may enable identification information to be received from each assembly module 200.

The speech recognition part 190 is an element that is formed at the control module 100 and recognizes speech from outside, and enables the coding work through speech recognition. The speech recognition part 190 may enable the moving of the entries e displayed in the first area a on the working screen 119 to the second area b and the selecting of the identification information for selecting an object item to be performed through speech recognition. The speech recognition part 190 may enable the entries e and the identification information displayed on the working screen 119 to be selected through speech and may enable the drag-and-drop operation to be performed for movement. Herein, the speech recognition part 190 recognizes the user's speech first so that an applicable menu is selected, and confirms the selection to enable control of the operation of the menu. To this end, the speech recognition part 190 may include a speech information reception module 191, an execution menu search module 192, an application confirmation module 193, a control command reception module 194, and a control application module 195.

The speech information reception module 191 is an element that receives speech information input to the control module 100. A general module capable of recognizing speech may be applied.

The execution menu search module 192 is an element that searches for an applicable menu according to speech received through the speech information reception module 191. The coding menu to which speech is applicable may be stored in advance, and it is searched whether the menu matching the received speech exists. For example, the execution menu search module 192 may set the moving of the entries e and the selecting of an object item as menus. When the speech containing the words “move an entry” and “select an object item” is received by the user, each operation may be performed.

The application confirmation module 193 is an element that causes the user to confirm the menus found by the execution menu search module 192. Information for confirming whether the found menus are correct may be displayed on the working screen 119. Accordingly, the application confirmation module 193 may display the messages “Is it correct to move the entry?” or “Is it correct to select the object item?” on the working screen 119. The user may input an answer thereto, yes or no, through speech.

The control command reception module 194 is an element that receives speech of a control command according to each menu when it is confirmed that the found menus are correct. According to the received speech, the coding work may be performed through the working screen 119. For example, when the menu “move an entry” is selected, the control command reception module 194 may check speech information for one of the entries e displayed in the first area a and may enable movement to a particular position in the second area b. Herein, the control command reception module 194 may receive speech for a particular entry e and may receive speech mentioning the number of the entry e to which movement is to be made for particular identification information in the second area b, or mentioning movement to a position above or below a particular entry e, so that the entry e is moved. In addition, regarding selection of the identification information for the object item, the control command reception module 194 may receive speech mentioning selection of particular identification information so that the identification information is selected. Accordingly, the control command reception module 194 enables the entry e or identification information on the working screen 119 to be selected and to be subjected to the drag-and-drop operation through speech input.

The control application module 195 is an element that applies the control command according to the speech received by the control command reception module 194 to coding. As described above, the control application module 195 may enable the selecting or moving of the entries e or identification information.

The assembly module 200 is an element formed to be attachable to or detachable from the playing block 20. For example, the assembly module 200 may be formed according to the specifications of the playing block 20, such as Lego. The assembly module 200 may be provided with a second communication part 270, an execution processing part 250, execution parts 210 and 230, a battery 290, a switching part 280, and a casing 209.

The second communication part 270 is an element that communicates with the control module 100, specifically, the first communication part 170. In order to be freely assembled to/disassembled from the block, the assembly module 200 may be formed independently from the control module 100. For this reason, the second communication part 270 may include a wireless module that communicates with the first communication part 170 using a wireless communication network, such as Wi-Fi, or Bluetooth.

The execution processing part 250 is an element that analyzes the control code received through the second communication part 270 and controls the execution parts so that various sensing values obtained from the execution parts may be transmitted to the control module 100.

The execution parts 210 and 230 are elements that performs set operations. The set operations may be an operation driven by a control code or a sensing operation of measuring the surrounding environment. The execution parts 210 and 230 may include the first execution part 210 and the second execution part 230.

The first execution part 210 may perform the set operation by a control code. For example, when the first execution part 210 is a motor, the set operation of the motor may be rotation. In addition, when the first execution part 210 is a display means, the set operation of the display means may be displaying image information included in the control code. When the first execution part 210 is a speaker, the set operation of the display means may be outputting sound.

The second execution part 230 may sense environmental information such as temperature, humidity, illumination, and pressure on a button, and the sensing operation may correspond to the set operation. Various information sensed through the second execution part 230 may be transmitted to the control module 100 through the second communication part 270.

The battery 290 may supply driving power to the second communication part 270 and the execution parts 210 and 230. To be assembled to/disassembled from the block, the assembly module 200 may be formed independently from an external power supply. Accordingly, the battery 290 may be used to independently supply the driving power required for the operations of the execution parts. In order to use the limited charged power in the battery 290 for a long period of time, it is advisable to prepare various power saving measures.

The switching part 280 is an element that switches the electrical connection of the battery 290 to the second communication part 270 and the execution parts. A pressure switch, of which the shape is deformed when external force is applied and of which the original shape is restored when the external force is removed, may be applied. The switching part 280 may be provided at a surface of the casing 209 facing the block. In order to minimize the phenomenon of the switching part 280 being pressed undesirably, the switching part 280 may be formed in a recessed part 209d. For example, when the switching part 280 may be pressed by a protrusion of the block when the protrusion of the block is inserted into the recessed part 209d. When the protrusion of the block is separated from the recessed part 209d, the pressure switch may be restored to its original state before being pressed by the elastic force of an elastic means provided inside. When the casing 209 is mounted on the block 20, the switching part 280 is physically pressed and the battery 290 may be electrically connected to the second communication part 270 and the execution parts (electrical connection is performed). The second communication part 270 or the execution parts electrically connected to the battery 290 may receive the driving power from the battery 290, and the ready state in which operation is possible by receiving a control code from the control module 100 may be entered. When a control code commanding the operations of the execution parts is obtained in the ready state, the execution parts may perform their natural operations (rotation for a motor) in earnest. In addition, when the casing 209 is separated from the block, the switching part 280 may return to its original state and may break the electrical connection of the battery 290 to the second communication part 270 and the execution parts. As a result, the battery 290 is electrically disconnected from the execution parts or the second communication part 270, and the standby power normally consumed by the execution parts and the second communication part 270 may be fundamentally suppressed. In the meantime, for convenience of coding, when the control module 100 is electrically connected to the battery 290 by the switching part 280 and receives the driving power, the identification information assigned to the assembly module 200 itself may be automatically transmitted to the control module 100.

The casing 209 is an element that forms the outer shape of the assembly module 200. The casing 209 may be formed together with the second communication part 270, the execution processing part 250, the execution parts 210 and 230, the battery 290, and the switching part 280, and may be formed according to the specifications of a playing block to be attachable to or detachable from the block. For example, in a surface 209b of the casing 209, the recessed part 209d in the shape of a recess into which the protrusion of the block is inserted in a forcibly fixed and fitted manner may be formed. In another surface 209a of the casing 209, a protrusion part 209c in the shape of a protrusion inserted into a recess formed in a block in a forcibly fixed and fitted manner may be formed.

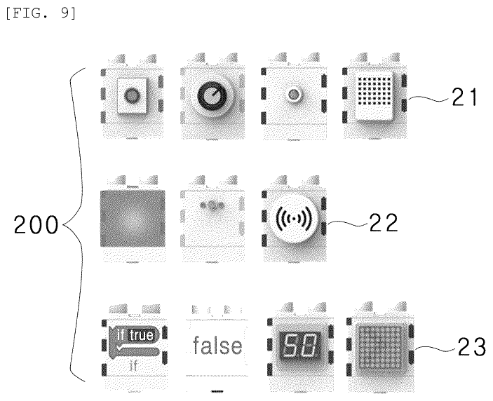

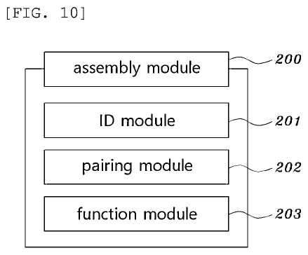

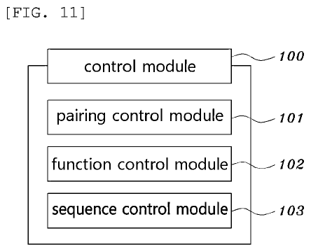

A coding algorithm training tool according to another embodiment of the present disclosure will be described with reference to FIGS. 9 to 11. The coding algorithm training tool includes a control module 100 and an assembly module 200 as in the above-described embodiment. The assembly module 200 is formed of input blocks 21, output blocks 22, and logic blocks 23. The assembly module 200 may further include an ID module 201, a pairing module 202, and a function module 203. The control module 100 may further include a pairing control module 101, a function control module 102, and a sequence control module 103.

The input blocks 21 are elements that enable the assembly module 200 itself to generate various input signals to interwork with another assembly module 200 and the control module 100. As a representative example, there is a switch block that generates a particular start signal or stop signal or a dial block that generates an adjustment signal for a particular intensity. In addition, the input blocks 21 may include a temperature/humidity block or illumination block that measures data such as temperature/humidity or illumination to generate input signals or a camera block that makes and transmits data such as a video.

The output blocks 22 are elements that enable the assembly module 200 itself to generate various output signals to interwork with another assembly module 200 or the control module 100. As a representative example, there is a speaker block that generates a particular sound signal or an LED block that displays a particular letter or number. In addition, the output blocks 22 may include a motor block that generates rotary driving force.

The logic blocks 23 are elements that enable the assembly module 200 itself to generate and transmit control signals required for various logical operations (including operations for realizing an algorithm or realizing coding).

Representative examples may include an operation symbol block that realizes operation symbol signals, such as +, −, ×, ÷, and =, required for mathematical operations and a case block that realizes signals such as the if, and true/false cases. In addition, the logic blocks 23 may include various blocks that generate and transmit signals required to realize various mathematical and logical operations.

In the meantime, the assembly module 200 may be formed to have various functions to expand the range of use as a variety of learning or playing tools in the present disclosure. To this end, specifically, the assembly module 200 may include: the ID module 201 including identification information; the pairing module 202 used for pairing connection with another assembly module 200; and the function module 203 capable of setting or modifying a particular function.

The ID module 201 is an element that includes unique identification information of a block itself. In order to conduct algorithm education or coding education using a plurality of assembly modules 200 used in various ways in the present disclosure, it is necessary to specify unique identification information or function of each of the plurality of assembly modules 200. For this purpose, the ID module 201 is an element that provides unique identification information of a block itself. Accordingly, the ID module 201 operates automatically as power is supplied to the assembly module 200 by the switching part 280, and transmits the stored identification information to the control module 100.

The pairing module 202 is an element that is used for pairing connection with another assembly module 200. TO connect a plurality of assembly modules 200 to each other for operation so as to perform a particular function, such as output according to input, the pairing module 202 is used to pair and connect the assembly modules 200 to be connected to each other to be used and operated. Accordingly, the pairing module 202 may perform a function of identifying target assembly modules 200 to be paired and connected and making pairing connection using Bluetooth between the target assembly modules 200. Various types of algorithms or coding education using a plurality of assembly modules 200 may be conducted.

The function module 203 is an element that enables a particular function of the assembly module 200 to be set or modified. Among the assembly modules 200 used in the present disclosure, in particular, in the case of the logic block 23 (also applicable to the input blocks 21 or the output blocks 22 when necessary), the functions values or condition values of the blocks need to be set or modified in various ways depending on the content of the target learning or play, so that various types of learning or play can be conducted even within a limited number of assembly modules 200. Therefore, the function module 203 may enable the setting or modifying of a particular function of the assembly module 200 to be performed, and the setting or modifying may be performed through the control module 100 according to the user's needs.

The pairing control module 101 is an element that transmits control signals related to the assembly modules 200 to be paired and connected and the pairing modules 202 of the assembly modules 200. The pairing control module 101 generates and transmits practical control signals for the pairing modules 202 in the assembly modules 200 described above. In order to conduct algorithm education or coding education using a plurality of assembly modules 200 used in various ways in the present disclosure, in particular, to perform a particular function, such as output according to input, the user is allowed to control pairing connection between the assembly modules 200 that can be operated by being connected to each other among the plurality of assembly modules 200.

The function control module 102 is an element that sets or modifies a particular function for the function module 203 of the particular assembly module 200. The function control module 102 generates and transmits practical control signals for the function module 203 in the assembly module 200 described above. The function values or condition values of the block need to be set or modified in various ways depending on the content of target learning or play, so that various types of learning or play can be conducted even within a limited number of assembly modules 200.

The sequence control module 103 is an element that sets a sequence related to an operating condition, operating order, and repetition for each assembly module 200 when the assembly module 200 is operated for learning or play. After input and output pairing connection between the target assembly modules 200 or setting for necessary functions of the assembly modules 200 to be used is completed for particular learning or play by the pairing control modules 101 and the function control modules 102, for practical purposes, certain functions of the target assembly modules 200 are performed first according to a certain order and then certain functions performed subsequently, so that continuous operations of the blocks are performed according to targeted learning content, thereby performing the corresponding mission. Therefore, the sequence related to the operating condition, the operating order, and repetition for each assembly module 200 may be set through the sequence control module 103. The sequence control module 103 is operated through the working screen 119 as in the above-described embodiment.

In addition, the pairing control module 101, the function control module 102, and the sequence control module 103 may be controlled through speech recognition. For example, the user may select a menu through speech, such as “pairing setting”, “function setting”, and “sequence setting”, and may select the assembly modules 200 of particular identification information so that pairing, function control, and sequence control are performed.

Although the application has described various embodiments of the present disclosure, the embodiments are only embodiments that realize the technical idea of the present disclosure. Any changes or modifications that realize the technical idea of the present disclosure should be constructed as belonging to the scope of the present disclosure.

1. A coding algorithm training tool, comprising:
an assembly module formed according to specifications of a playing block to be attachable to or detachable from the block; and
a control module configured to set operation of the assembly module through coding and modify or change the operation, and enable coding of a control command for the assembly module through speech recognition.

2. The coding algorithm training tool of claim 1, wherein the control module comprises
a speech recognition part configured to recognize speech and apply the speech to coding,
wherein the speech recognition part comprises:
a speech information reception module configured to receive the speech from outside; an execution menu search module configured to select a menu to be applied to coding, according to the received speech; an application confirmation module configured to output a confirmation signal for the found menu; a control command reception module configured to receive the control command according to the speech when the menu is confirmed; and a control application module configured to apply the received control command to coding.

3. The coding algorithm training tool of claim 2, wherein the control module comprises:
an interface part configured to provide a working screen for coding the control command for the assembly module; and
a coding processing part configured to compile content coded on the working screen of the interface part, and transmit a control code resulting from compiling to a particular assembly module so that operation according to the control code is performed.

4. The coding algorithm training tool of claim 3, wherein the interface part comprises:
a first area in which a plurality of selectable command entries are displayed on the working screen; and a second area to which the entries selected in the first area are dragged and dropped,
the coding processing part comprises:
a compile processing module configured to compile the entries according to arrangement order of the plurality of entries arranged in the second area; and a control code transmission module configured to transmit the control code resulting from compiling by the compile processing module to the assembly module, and
the control command reception module is configured to enable the entries in the first area to be dragged and dropped to the second area according to the command based on the speech.

5. The coding algorithm training tool of claim 4, wherein the interface part is configured to display the entries in everyday terms in the first area, and
the coding processing part comprises a conversion processing module configured to convert the everyday terms into programming language for compiling by the compile processing module.

6. The coding algorithm training tool of claim 4, wherein the coding processing part comprises:
a flaw analysis module configured to analyze a flaw in the control code resulting from compiling by the compile processing module; and a flaw display module configured to display the flaw on the working screen when the flaw exists as a result of analysis by the flaw analysis module, and
the control code transmission module is configured to transmit the control code resulting from compiling to the assembly module when the flaw analysis module determines that there is no flaw.

7. The coding algorithm training tool of claim 3, wherein the assembly module comprises:
a casing formed to be attachable to or detachable from the playing block; an execution processing part configured to receive a control code from the control module so that operation according to the control code is performed; and a battery configured to supply power to the assembly module.

8. The coding algorithm training tool of claim 7, wherein the assembly module comprises an ID module configured to store identification information of each assembly module, and transmit the stored identification information to the control module, and
a coding processing part comprises a coding target specifying module configured to specify a coding target according to selection of the identification information transmitted by the ID module.

9. The coding algorithm training tool of claim 8, wherein the coding target specifying module comprises:
an identification information display module configured to display the identification information transmitted by the ID module on a working screen; an identification information selection module configured to enable, when the identification information displayed by the identification information display module is selected for an object item of entries or dragged and dropped to the object item, the identification information to be selected as the coding target; and an identification information designation module configured to designate the selected identification information as the coding target for the entries, and
the control application module is configured to enable the identification information to be selected for or to be dragged and dropped to the object item according to reception of a speech command.

10. The coding algorithm training tool of claim 9, wherein the assembly module comprises a switching part configured to enable power to be supplied from the battery to the assembly module according to combination of the casing to the block, and
the ID module is configured to operate automatically as the power is supplied from the battery by the switching part, and transmit the identification information to the control module.

11. The coding algorithm training tool of claim 10, wherein the switching part comprises
a pressure switch configured to be physically pressed to make electrical connection to the battery when the casing is mounted on the block, and configured to return to an original state to break the electrical connection when the casing is separated from the block.

12. The coding algorithm training tool of claim 7, wherein the assembly module comprises:
an input block configured to generate and transmit various input signals; an output block configured to output various output signals; and a logic block configured to generate and transmit control signals required for various logical operations.

13. The coding algorithm training tool of claim 12, wherein the assembly module comprises:
a pairing module configured to enable information to be transmitted and received through pairing between the assembly modules; a function module configured to enable a particular function to be set or modified; and a sequence control module configured to set a sequence related to an operating condition, operating order, and repetition for each of a plurality of the assembly modules.

14. The coding algorithm training tool of claim 13, wherein the control module comprises:
a pairing control module configured to transmit a control signal related to pairing connection to the assembly module; and a function control module configured to set or modify a particular function for the function module of a particular assembly module.
